(19) United States
(12) Patent Application Publication
(10) Pub. No.: US 2007/0262766 A1
(43) Pub. Date: Nov. 15, 2007

(54) Current mirror for high frequency monolithic integrated circuits

(75) Inventor: Gregory Yuen, Cambridge (GB)

Correspondence Address: KENYON & KENYON LLP, 1500 K STREET N.W., SUITE 700, WASHINGTON, DC, 20005, US

(73) Assignee: SiGe Semiconductor Inc., Ottawa (CA)

(21) Appl. No.: 11/431,825

(22) Filed: May 11, 2006

(51) Int. Cl. G05F 3/16

(52) U.S. Cl. 323/315

(57) ABSTRACT

A current-mirror circuit for monolithic integration in semiconductor microwave circuits is presented which overcomes the detrimental aspects of the emitter-follower current mirror resulting in improved accuracy and stability of the current mirror even under low voltage operation of circuits with high emitter-bias voltages such as GaAs. Advantageously the circuit can be implemented solely with NPN transistors and resistors allowing the circuit to be compatible with the reduced manufacturing processes and design options on high frequency materials such as GaAs and InP. The invention can be applied to low emitter-bias voltage materials such as Si and SiGe to offer increased accuracy and stability, and lower power supply levels.

### FIELD OF THE INVENTION

The invention relates to the field of current mirrors for monolithic microwave amplifiers and more specifically their design for low voltage applications with semiconductor technologies offering limited cell elements.

### BACKGROUND OF THE INVENTION

In the past sixty years the use of wireless and RF technology has increased dramatically, and in ways few could have foreseen then, from limited military radar applications to today's ubiquitous penetration of wireless and microwave technology. The applications have expanded immensely but equally also have the volumes and customer base as applications such as RFID and cellular telephony have taken hold, but also in terms of functionality and complexity, and expectations of the consumers and users of these systems.

Today the plain old telephone for most people is now a portable, highly compact and light communications centre which provides not only telephony but also Internet access for email, web browsing and up-loading or downloading files together with music player, camera, and personal data assistant (PDA). At the same time computers occupying large air conditioned rooms have become lightweight portable laptops, palmtops, and tablets, which we routinely use and increasingly do so wirelessly both within our own houses, coffee shops, airports and shopping malls.

Additionally our automobiles include global positioning systems, onboard navigation, wireless connectivity to emergency services, and RFID for paying tolls on highways without slowing down. Overall users expectat all of these devices to operate flawlessly, without interruption, in remote areas as well as densely populated urban environments, have increased battery lifetime, operate seamlessly without intervention worldwide, and to increase features, speed and inexpensiveness over time as semiconductor technology advances and volumes increase.

The result is the semiconductor technology for providing monolithic microwave circuits is continually advanced to squeeze lower power consumption, increase efficiency, increase stability, lower cost and increase integration. The technology is preferably applicable across multiple international standards such as:
GSM, which represents the most commonly accessed wireless technology for today's consumers in their cellular telephone. Strictly covering five frequency bands of which 4 are considered and provided for global roaming of a single wireless device, 0.85 GHz, 0.90 GHz, 1.8 GHz and 1.9 GHz.
Wi-Fi for wireless devices operating in compliance with the IEEE 802.11 standards. Of these, 802.11b and 802.11g represent systems operating in the 2.4 GHz range, and 802.11a for devices operating in the 5 GHz range.
WiMAX (Worldwide Interoperability for Microwave Access) is the standard for devices operating according to IEEE 802.16 addresses the “first-mile/last-mile” connection in wireless metropolitan area networks. WiMAX focuses on efficient use of bandwidth between 10 and 66 GHz primarily, although the 2 GHz to 11 GHz range has now been added to provide mesh network topology options. Licensed frequencies are commonly centered on 10.5 GHz, 25 GHz, 26 GHz, 31 GHz, 38 GHz and 39 GHz.
HIPERMAN (High Performance Radio Metropolitan Area Network) is the mirror European Telecommunications Standards Institute (ETSI) standard for Europe for broadband wireless access networks and similarly is designed to operate within the 2 GHz to 11 GHz range.
DSRC (Dedicated Short Range Communications) is a short to medium range protocol specifically designed for communication between a vehicle and roadside equipment. It is a sub-set of RFID technology, but at higher frequencies, where standards are established around 5.8 GHz and 5.9 GHz.

The result is providers of wireless integrated circuits must be capable of providing them across a frequency range from below 1 GHz (GSM) to potentially 66 GHz (WiMAX). The wide frequency range results is manufacturers of integrated circuits operating in multiple semiconductor technologies as silicon does not easily support the frequency range, and hence integrated circuits are provided using semiconductor platforms such as SiGe, GaAs and InP.

However, these semiconductor materials do not provide for all the design flexibility designers have available within silicon, and as a result monolithic integration in these platforms has been substantially less than with silicon microwave circuits despite the fact that these high volume, consumer applications demand similar price-performance-functionality tradeoffs for a 39 GHz first mile subscriber access solution as they do for an 850 MHz cellular telephone.

In the design of electronic circuits, it is a common requirement to set up single or multiple scaled currents from a reference current, for example within amplifiers and analog-to-digital converters (ADC). These are typically implemented using a simple current-mirror constructed from a pair of transistor devices where the appropriate scaling of currents is achieved from the scaling of the emitter areas of the transistors. Whilst providing a reasonable solution, in many systems a practical limitation arises from the loading effects of the transistor base currents on the reference current set up, which introduces error and limits the maximum practical scaling factor.

Traditionally, mitigation is achieved by adding a third transistor to the current mirror, typically referred to as an emitter-follower. With this, the loading effect on the reference current is the much smaller base current of the emitter-follower transistor. Essentially the current gain of the emitter-follower buffers the load current formed by the total base current of the reference side and current sink transistors.

However, typically the reference current is set from a regulated voltage with a series resistor as a simple and stable design. However, in reducing the impact of load currents, the voltage drop across the reference resistor is now reduced due to the need to drop twice the transistor base-emitter voltage (Vbe), as compared to the prior art simple current mirror. This results in the current mirror circuit exhibiting poorer regulation against voltage and temperature variations.

Historically, these effects were of little significance with power supply voltages of 5V and higher in systems. But today's modern electronic equipment is now powered at 3V, which significantly aggravates voltage and temperature effects even for silicon microwave circuits where Vbe=0.7V and hence the voltage drop across the reference resistor is 3−1.4=1.6V, much reduced compared to a 5V system. SiGe bipolar transistors which represents a semiconductor technology offering higher frequency operation than silicon bipolar transistors has a Vbe=0.8V and hence drops 3−1.6=1.4V within the reference resistor, reducing further the stability of the reference current circuit to voltage supply variations, from effects such as battery aging, battery drain and manufacturing tolerances, along with temperature effects.

However, to cover the full microwave spectrum for wireless applications additional semiconductor platforms such GaAs and InP offer very high frequency, high efficiency and low power amplifiers, mixers, oscillators and other elements of the microwave circuit. Considering GaAs, the Vbe is typically 1.3V such that for the typical current mirror of the emitter-follower design, only 3−2.6=0.4V is left across the reference current setting resistor.

It would be advantageous therefore for designers implementing high frequency microwave circuits in these technologies to have available a current-mirror circuit that preserves the advantages of the emitter-follower design and the improved accuracy and stability of the original single Vbe drop. It would be further advantageous if the approach was compatible with future reductions in power supply voltages to even lower than today's 3V standard.

It would further be advantageous for the new current-mirror which has advantages even for low Vbe technologies such as Si/SiGe to accommodate the limited building blocks available with the high Vbe technologies such as GaAs and InP offering typically only NPN transistors and resistors, as opposed to the PNP transistors and/or CMOS available to facilitate the design of more sophisticated circuits in Si/SiGe.

### SUMMARY OF THE INVENTION

In accordance with the invention there is provided an enhanced current mirror circuit, which comprises a basic simple current mirror circuit comprising at least two transistors. Electrically coupled to an input port of the current mirror is a current setting resistor, the current setting resistor also coupled to a voltage supply potential for defining the current to be mirrored. An emitter follower component is electrically coupled to both a switching port of the current mirror and the current setting resistor. Additionally a level shifting component, provided to shift a bias of the emitter-follower component, is provided and is electrically coupled between both a switching port of the emitter follower component and an input port of the current mirror circuit. Finally there is provided a compensating component, which provides a compensating current for that drawn through the level shifting component. The compensating component is electrically coupled to the input port of the current mirror circuit.

In accordance with another embodiment of the invention the enhanced current mirror is provided an integrated circuit which is manufactured from a semiconductor material, the semiconductor material being at least one of Si, SiGe, GaAs, and InP.

In accordance with a further embodiment of the invention the enhanced current mirror is integrated within the semiconductor material with a microwave integrated circuit for the processing of a microwave signal.

### BRIEF DESCRIPTION OF THE DRAWINGS

Exemplary embodiments of the invention will now be described in conjunction with the following drawings, in which:

FIG. 1 illustrates a prior art embodiment of a simple current mirror.

FIG. 2 illustrates a prior art embodiment of an emitter-follower current mirror.

FIG. 3 illustrates a first embodiment of the invention wherein a current mirror is provided with the combined advantages of both the simple current mirror and emitter-follower design using solely NPN transistors and resistors.

### DETAILED DESCRIPTION OF EMBODIMENTS OF THE INVENTION

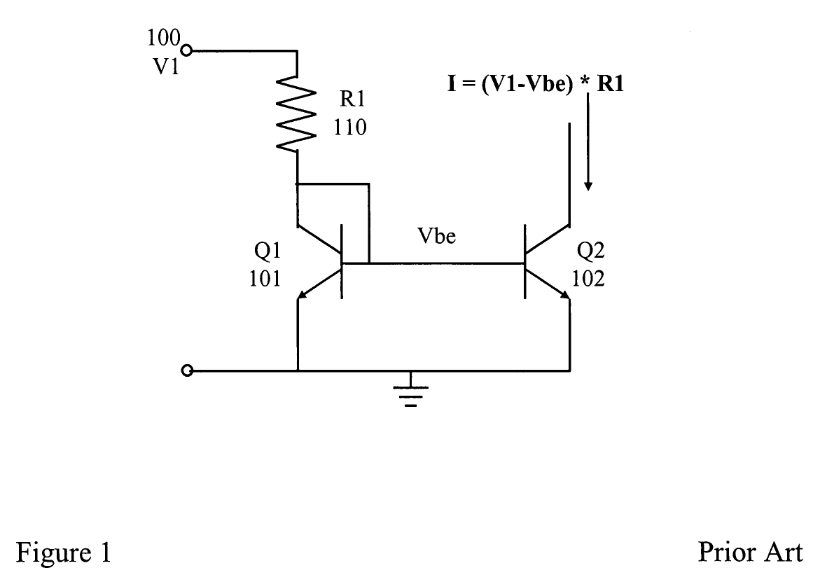

FIG. 1 illustrates a prior art embodiment of a simple current mirror. The current mirror having an input port, to which is provided the current to be mirrored, and an out port which provides to subsequent circuitry the mirrored current. Here a power supply voltage V1 is applied to the current mirror input port 100. This is electrically coupled to the reference resistor R1 110. The reference resistor R1 110 is also electrically connected at its other end to the collector and base contacts of the first transistor Q1 101. The emitter contact of the first transistor Q1 101 is electrically coupled to ground as is the emitter contact of the second mirror transistor Q2 102. The base contact of the second transistor Q2 102 is electrically connected to the base contact of the first transistor Q1 101. As a result the reference current flowing through the resistor R1 is mirrored to the collector port of the second transistor Q2 102. The current flowing on the left hand side is defined by I=(V1−Vbe)/R1, wherein Vbe represents the base-emitter bias of the transistor Q1 101, typically 0.7V for Si, 0.8V for SiGe and 1.3V for GaAs. In the embodiment shown the transistors Q1 101 and Q2 102 are shown having equal emitter areas and hence the current flowing in the mirror arm is also (V1−Vbe)/R1. It is evident to one skilled in the art that increasing the emitter area of the second transistor Q2 102 relative to first transistor Q1 101 results in a magnified mirror of the current provided by the circuit, and equally a reduced scaled mirror current is provided for the case where the emitter area of the second transistor Q2 102 is decreased relative to first transistor Q1 101.

As such the circuit provides a very simple means of providing a reference current to a microwave integrated circuit. However, a practical limitation of this circuit is the loading effect of base currents where high scaling is required, such as within amplifiers, analog-to-digital converters (ADCs) and digital-to-analog converters (DACs). In these scenarios the base currents affect the reference current set up in R1 110, thereby introducing error and hence limiting the maximum practical scaling factor.

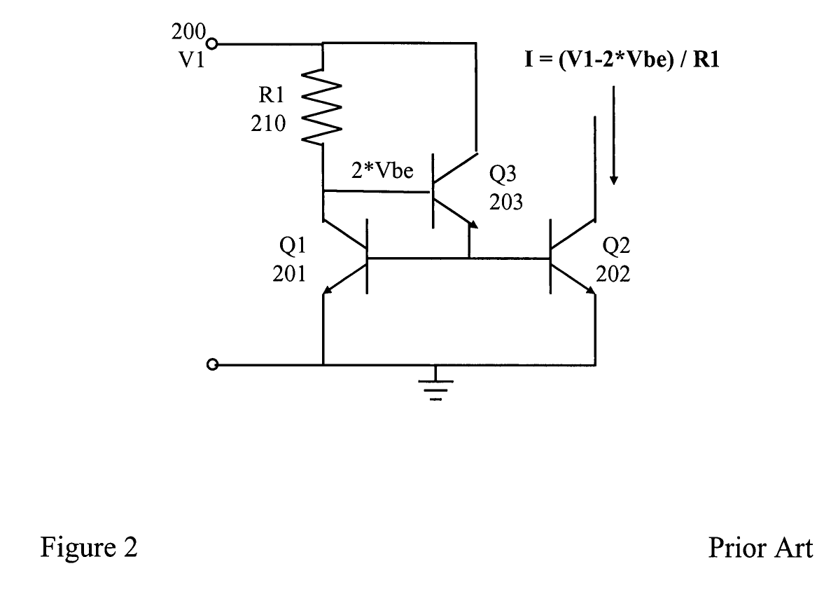

FIG. 2 illustrates a prior art embodiment of an emitter-follower current mirror, which is designed to reduce these base current induced errors. Here a power supply voltage V1 is applied to the current mirror input port 200. This is electrically coupled to the reference resistor R1 210. The reference resistor R1 210 is also electrically connected at its other end to the collector contact of the first transistor Q1 201, and the base contact of the third transistor Q3 203. The collector contact of the third transistor Q3 203 is electrically connected to the power supply voltage V1.

The emitter contact of the first transistor Q1 201 is electrically coupled to ground as is the emitter contact of the second mirror transistor Q2 202. The base contact of the second transistor Q2 202 is electrically connected to the base contact of the first transistor Q1 201, and the emitter contact of the third transistor Q3 203. The resulting configuration is commonly referred to as an emitter-follower design. As a result the reference current flowing through the resistor R1 is again mirrored to the collector port of the second transistor Q2 202. However, now the base contacts of the third transistor is at a potential 2*Vbe with respect to ground such that potential drop across the reference resistor R1 210 is now (V1−2*Vbe).

The resulting current flowing in the left side of the current mirror is (V1−2*Vbe)/R1. For equal emitter areas, of the first transistor Q1 201 and second transistor Q2 202, the resulting current provided to the connected microwave circuit from the right side of the current mirror is (V1−2*Vbe)/R1. As with FIG. 1 it would be evident to one skilled in the art that with appropriate selection of the first transistor Q1 201 and second transistor Q2 202 based upon emitter area that the current applied by the right hand side of the current mirror would be scaled in the ratio of the emitter areas Q2/Q1. Now the dependency of the reference current within R1 210 from the base emitters of the current mirror pair is reduced as the emitter-follower assembly of the third transistor Q3 203 buffers the load current.

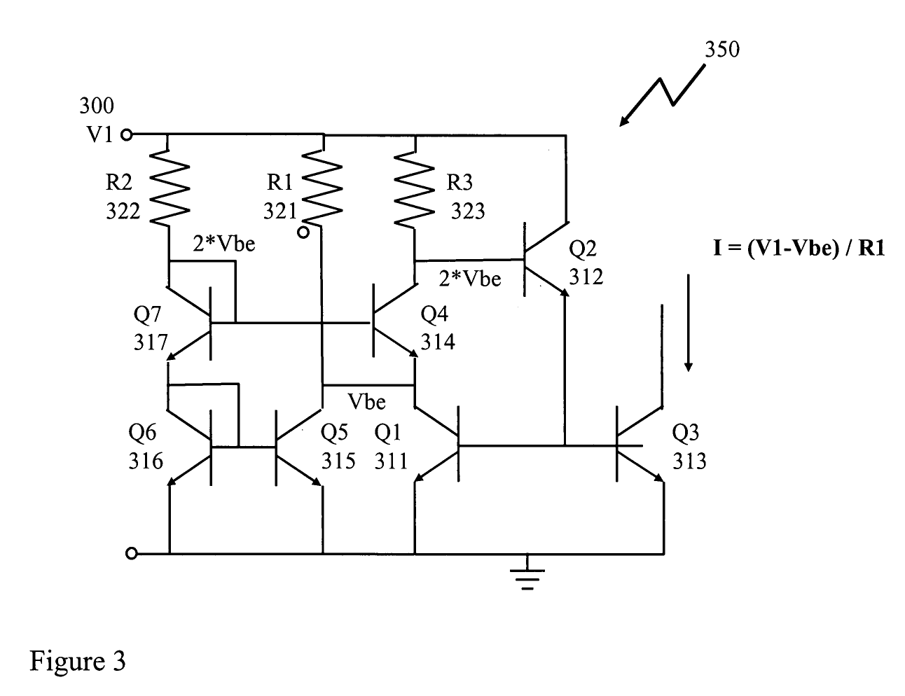

FIG. 3 illustrates a first embodiment of the invention. Shown is the first mirror transistor Q1 311 of the modified current mirror circuit 350. As outlined supra the collector terminal of the first transistor Q1 311 is electrically coupled to the reference resistor R1, although as opposed to directly as in FIG. 2 a level-shifting transistor Q4 314 is interposed. As with FIG. 2 the base terminals of the first mirror transistor Q1 311 and second mirror transistor Q3 313 are electrically connected. Likewise the emitter terminals of the first mirror transistor Q1 311 and second mirror transistor Q3 313 are electrically coupled and held at ground. The third mirror transistor Q2 312 has an emitter terminal coupled to the base terminals of the first mirror transistor Q1 311 and second mirror transistor Q3 313, and a base terminal coupled to the lower end of the resistor R3 323. The upper end of the reference resistor R3 423 is at voltage V1, which is applied at the voltage supply port 300.

The level-shifting transistor Q4 314 is electrically disposed in this arrangement between the collector terminal of the first mirror transistor Q1 311 and base terminal of the third mirror transistor Q2 312. As such the level-shifting transistor Q4 314 forces the voltage of Vbe onto the collector terminal of the first mirror transistor Q1 311.

Compensating transistor Q5 315 compensates the operating current of the level-shifting transistor Q4 314. In this manner first mirror transistor Q1 311 carries only the current in R1 321.

The base voltages of level shifting transistor Q4 314 and compensating transistor Q5 315 are set up by resistor R2 322, which is electrically connected to the voltage V1 which is applied at the voltage supply port 300, and the diode-connected transistors Q6 316 and Q7 317, which are electrically disposed between the lower end of the resistor R2 322 and ground. The current flowing in level shifting transistor Q4 314 is given by (V1−2Vbe)/R3. To make compensating transistor Q5 315 carry the same current, we make R2=R3. As the base and emitter terminals of the transistors result in a switching of the bias offset into effect for the current setting resistor we refer to them subsequently as switching ports of the transistor devices.

In this manner the current flowing in the mirror circuit is defined by I=(V1−Vbe)/R1 as with the original current mirror, but now the emitter-follower advantages of reduced base current loading have been added and the detrimental increase in the offset potential to 2Vbe removed through the addition of the level compensating transistor Q4 314. In the description so far it has been assumed that Q4, Q5, Q6 and Q7 are all the same size. This assumption was made to simplify the description though one of skill in the art will appreciate that this need not be so. For example, current savings result in the current mirror circuit by making diode-connected transistors Q6 316 and Q7 317 with smaller areas and therefore resistor R2 correspondingly higher in value without changing the operation of the circuit.

As with the discussions supra the current mirror described herein has been set to magnify at unity for simplicity by considering equal emitter areas of the first mirror transistor Q1 311 and second mirror transistor Q3 313. Changing the area of these transistors relative to one another allows the current mirror to magnify the reference current in the operation of the broader microwave circuit. It is evident to one skilled in the art that such magnification is optionally greater, equal, or less than unity.

As outlined in FIG. 3, the required functionality of the current mirror circuit described herein is implemented solely through the use of NPN transistors and resistors. As such the approach is compatible with high frequency semiconductor circuits manufactured using GaAs and InP as well as those on Si and SiGe. Alternatively, other components are used.

Numerous other embodiments may be envisaged without departing from the spirit or scope of the invention.

What is claimed is:

1. A circuit comprising:
a first current mirror circuit comprising at least two transistors;
a current setting resistor electrically coupled to an input port of the current mirror; the current setting resistor also coupled to a voltage supply potential;
an emitter follower component coupled to a switching port of the current mirror and the current setting resistor;
a level shifting component for shifting a bias of the emitter-follower component, the level shifting component coupled between a switching port of the emitter follower component and an input port of the current mirror circuit; and
at least a compensating component for compensating current through the level shifting component, the compensating component coupled to the input port of the current mirror circuit.

2. A current mirror according to claim 1, wherein at least one of the compensating component, level shifter component, and emitter follower component comprises a transistor.

3. A current mirror according to claim 2, wherein the transistor is an NPN transistor.

4. A current mirror according to claim 1, wherein at least one of the compensating component, level shifter component, and emitter follower component consists of a transistor.

5. A current mirror according to claim 4, wherein the transistor is an NPN transistor.

6. A current mirror according to claim 1, wherein, in use, the potential difference across the current setting resistor is approximately equivalent to that established with the first current mirror circuit alone.

7. A current mirror according to claim 1 wherein:
the compensating component has a first bias voltage applied thereto, the first bias voltage coupled to the switching port of the compensating component; and
the level shifting component has a second bias voltage applied thereto, the second bias voltage being coupled to the switching port of the level shifting component.

8. A current mirror according to claim 7, wherein at least one of the first and second bias voltage is coupled from a bias setting circuit.

9. A current mirror according to claim 8, wherein the bias setting circuit comprises at least a transistor.

10. A current mirror according to claim 8, wherein the bias setting component is an NPN transistor.

11. A current mirror according to claim 1, wherein, in use, the current flowing through the level shifting component is approximately compensated by the current flowing through the compensating component.

12. A current mirror according to claim 1, wherein the current mirror is integrated within an integrated circuit.

13. A current mirror according claim 12, wherein the integrated circuit is manufactured from a semiconductor material, the semiconductor material selected from a group of semiconductor materials consisting of Si, SiGe, GaAs, and InP.

14. A current mirror according to claim 1, wherein the current mirror is integrated with a semiconductor integrated circuit to provide a microwave integrated circuit, the microwave integrated circuit for processing a microwave signal.

15. A current mirror according claim 14, wherein the microwave integrated circuit is manufactured from a semiconductor material, the semiconductor material selected from a group of semiconductor materials consisting of Si, SiGe, GaAs, and InP.

16. A method comprising:
providing a first current mirror circuit, the first current mirror circuit comprising an input port, a switching port, a first transistor, and a second transistor;
providing a current setting resistor, the current setting resistor coupled serially between the input port of the first current mirror circuit and a voltage supply potential;
providing an emitter follower transistor comprising a switching port, the emitter follower transistor coupled to the switching port of the current mirror and the current setting resistor;
providing a level shifting component, the level shifting component for shifting a bias of the current mirror circuit at the current setting resistor, the level shifting component coupled between the switching port of the emitter follower component and the input port of the current mirror component; and
providing at least a compensating component, the compensating component for compensating current through the level shifting component, the compensating component coupled to the input port of the first current mirror circuit.

17. A method according to claim 16, wherein the step of providing at least one of the emitter follower component, compensating component, and level shifting component is the provision of a transistor.

18. A method according to claim 17, wherein providing a transistor is accomplished by providing an NPN transistor.

19. A method according to claim 16, wherein the method is implemented as an integrated circuit.

20. A method according claim 19, wherein the integrated circuit is manufactured from a semiconductor material, the semiconductor material being at least one of Si, SiGe, GaAs, and InP.

21. A method according to claim 16, wherein the current mirror is integrated with a semiconductor integrated circuit to provide a microwave integrated circuit, the microwave integrated circuit for processing a microwave signal.

22. A method according claim 21, wherein the microwave integrated circuit is manufactured from a semiconductor material, the semiconductor material being at least one of Si, SiGe, GaAs, and InP.

23. A method comprising:
providing a first current mirror circuit, the first current mirror circuit comprising an input port, a switching port, a first transistor, and a second transistor;
providing current to the first current mirror circuit;
using an emitter follower, driving current from the current mirror circuit;
shifting a bias of the current mirror circuit with a level shifting component; and
compensating current through the level shifting component.

24. A storage medium comprising instruction data stored therein for when executed resulting in a circuit comprising:
a first current mirror circuit comprising at least two transistors;
a current setting resistor electrically coupled to an input port of the current mirror; the current setting resistor also coupled to a voltage supply potential;
an emitter follower component coupled to a switching port of the current mirror and the current setting resistor;
a level shifting component for shifting a bias of the emitter-follower component, the level shifting component coupled between a switching port of the emitter follower component and an input port of the current mirror circuit; and
at least a compensating component for compensating current through the level shifting component, the compensating component coupled to the input port of the current mirror circuit.
